(19) United States
(12) Patent Application Publication
(10) Pub. No.: US 2008/0244714 A1
(43) Pub. Date: Oct. 2, 2008

(54) Secure RFID authentication system using non-trusted communications agents

(76) Inventors: Michael Kulakowski, (US); Robert Kulakowski, (US)

Correspondence Address: MICHAEL KULAKOWSKI, 5 CARLSON COURT, JACKSON, NJ, 08527, US

(21) Appl. No.: 11/728,792

(22) Filed: Mar. 27, 2007

(51) Int. Cl. G06Q 99/00

(52) U.S. Cl. 726/5

(57) ABSTRACT

The electronic Secure Authentication For Exchange Global Purchasing System (GPurs) facilitates interactions between customers and service/retail commercial enterprise whereby a Global Positioning System (GPS) like system is used to search, locate, reserve, schedule, order or purchase numerous products and services through a secure system that employs product encryption safeguards against counterfeit, diverted or pirated products, and to reserve, order or purchase services that meet quality standards. The GPurs system presents a digital graphical user interface to accept customer input, an audio interaction system speech recognition engine linked microphone or cellular telephone, a digital device interface that accepts textual input from a cellular telephone, PC, PDA, IPod, DVD controller, game controller, or an on-board automotive integrated computer or a wireless input system, to search, locate, reserve, schedule, order or purchase products and services. All GPurs data is stored and retrievable for later usage.

This invention serves to establish a trusted authentication network environment for authenticating products and product related RFID data using non-trusted communication agents such as non-secure in-store readers, non-secure RFID readers, cash registers, local network access points, a cellular telephone, etc. This invention presents a means toward connecting a consumer's RFID reader to a Trusted Authentication Service Network. Secure wireless WI-FI communication links are thereby established between the cellular telephone (preferred embodiment), cash register, credit card reader, etc. that is connected directly to the Authentication Service Network.

The consumer digital devices (RFID Reader, Cellular Telephone equipped with an RFID Reader, laptop computer equipped with an RFID Reader, PDA equipped with an RFID Reader, Secure ID reading device, Personal Digital Appliance PDA, Personal Computer, Laptop or Notebook computer, electronic wallet, terminal, MP3 player, video ipod, conventional ipod, etc.) used to conduct in-store purchase and credit card purchase transactions are authenticated prior to the exchange of any associated product data or availability of services or the provision of services. Upon successful device authentication the product's electronic pedigree via a cryptographic authentication challenge (as specified within “Secure authentication system for collectible and consumer items” Patent Application #11157282) using the product's RFID tag within the Authentication Service Network. A product's successful RFID authentication challenge results will be conveyed to the user (via the consumer devices user interface(s)) indicating the non-counterfeit, non-pirated, non-diverted, etc. status of the product and the user is advised to complete the purchase transaction. In instances when a product's cryptographic authentication challenge results in a “failed, compromised, or inconclusive” determination, the user is alerted (via the consumer devices user interface(s)) that the product is possibly counterfeited, pirated diverted, etc.

This patent application enhances the “Secure Authentication System for Collectable and Consumer Items” patent application and the “For a Secure RFID Authentication System” patent application both filed by Michael Kulakowski and Robert Kulakowski and referred to herein as Prior Applications.

The Prior Applications described new inventions to securely authenticate items and described inventive new secure readers and secure product authentication. This patent application enhances the prior applications by describing a trusted authentication environment whereby a consumer RFID reader can be trusted when no cellular telephone network connectivity is available as described in the “For a Secure RFID Authentication System” patent application (Prior Application). In fact, this invention establishes a trusted authentication environment for authenticating product RFID tags and related RFID information using non-trusted communication agents such as non-secure in-store readers, local network access points, and other means of connecting a consumer RFID reader to a Trusted Authentication service.

In this patent application the term Near Field Communication (NFC) includes what are considered electrically near field communications methods such as RFID, Infrared Communications (IRDA and other forms or infrared), or traditional radio communications methods including any form of radio frequency technology, or local wired and wireless network technology including Bluetooth, ZigBee, WiFi, 802.11a,b,g,e, Ultra-wideband, GSM, GPRS, CDMA, Ethernet, text message based Short Message System (SMS), wireless and wired Internet Protocol (TCP/IP) communications over any transmission medium and other networking technology that can support local networking. Local networking includes communications between RFID (tags) in products and cellular telephone, between RFID (tags) in product and in-store RFID reader, credit card reader (possibly equipped with an RFID reader), or cash register (possibly equipped with an RFID reader), between cellular telephone and in-store reader or cash register, or between cellular telephone and remote authentication services. Even though not necessarily limited to Near Field Communications, NFC can also include transmission mediums that can provide local and long distance networking via local links to gateways, translators (for example, Bluetooth to Ethernet), RFID chip emulation (having the local device emulate an RFID device), and other forms of communications between a RFID (tag and reader) and a Authentication Service (Trusted Authority from Prior Patents). The term NFC as used in this patent application also applies to any type of local connection technology including any type of network whatever the connection means (wired, wireless, infrared, sonic, etc.).

As used in this patent application the term symmetrical key encryption including DES, AES, IDEA, Blowfish, RC4, and other algorithms; Public-key algorithms including RSA, Diffie-Hellman, DSA, and others; One-Way Hash Functions including SHA, RIPE-MD, MD4-3versions, MD5-2 versions, N-Hash, and others.

In this patent application the term “secure communications” means communications that is encrypted using public/private key pairs, or symmetrical key encryption with keys shared between the communications points, or with smart card or SIM based cryptographic processing “Secured communications” can also include authentication unique or cryptographic ID's of items such as RFID tag in product 560, cellular telephone 540, in-store cash register or credit card terminal or in-store rfid reader (separately or combined) (520), and Authenticator Services 510, communications points using Public/Private Keys, X.509 digital certificates, hardware encryption keys, secure processing elements, virtual private networks, and other methods and techniques used to establish authenticated and encrypted communications between two elements. The term “secure communications” entails the use of ‘best of breed’ encryption and authentication techniques and it is anticipated within this patent application that symmetrical key encryption can be substituted with public key infrastructure and vice versa. It is also anticipated that the term “device authentication” encompasses ‘best of breed’ authentication using cryptographically secure encryption keys, digital signatures, or other methods of authenticating a chip (RFID tag) or product.

In this patent application the term “module”, “component” or “function” is used to describe the functionality of an operation regardless of where the operation is physically performed. Modules can execute directly within a cellular telephone or can be distributed across a system or network and can run as a server side application, a web service, via an interface to a remote system using some form of Remote Procedure Call RPC, Secure Socket Layer (SSL) protocol with application code performing module functionality, using Microsoft .net or Simple Object Access Protocol SOAP, application server, application software, Java Script, Java servlet, Java plug-in, Messaging Service, native Java application or other actual implementation that can be used to perform the processing details for the module. Encrypted versions of the distributed communications, application code, APIs, and protocols necessary to perform module functionality are also included in the term “module”, as well as processing performed in hardware, software, or firmware, resident locally on a chip or device or performed on a network attached computer or processing element.

In this patent application the term “cryptographically unique identifier” is used to indicate that a product, item, network element, reader, phone, or communications component can be uniquely identified using a security element or encryption key, or encryption key pair, and that the use of the cryptographically unique identifier is used to identify and/or secure communication between different system elements, network elements, network communications or communications channels between the elements in the Purchase Authentication Network described in this patent application. There are many secure communications protocols that can be used by the Purchase Authentication Network to establish a secure Virtual Private Network (VPN) between one or more of the elements (product rfid, reader, phone, credit card reader, cash register, other network elements and Authentication Services or Trusted Authority). This patent application anticipates the use of any method of establishing secure communications for use to allow a trusted authentication network to be established. This patent application also anticipates the use of any communications protocol, encryption, element or device authentication that can be applied to establish the trusted authentication network of this invention. Likewise, individual element of this invention (product RFID, phone, RFID or credit card reader, cash register, secure authentication terminal) can utilize any method or means to authenticate an element using any cryptographic method of authentication including embedding cryptographic keys in the element, adding smart cards, encryption keys in the form of encryption dongles plugged into USB, parallel ports, serial ports, or other ports; SIM type smart cards typically used in cellular telephones, embedded security elements added onto the motherboard or main boards of computers, phones, electronic assemblies and parts.

Additionally, as use in this patent the term “ID” includes a single unencrypted identifier (digital value or number), an unencrypted digital value plus a cryptographically unique hash or key value, an unencrypted digital value plus a cryptographically unique identifier, an unencrypted digital value plus a cryptographically unique key value or key pair value, or similar type identifier.

### LIST OF FIGURES

FIG. 1—top block shows a high level diagram of an RFID reader incorporating a security element.

FIG. 1—middle block shows that it is envisioned by this patent that the secure RFID reader can be integrated into a wireless e-commerce terminal used for wireless payment (credit/debit/money cards) that are starting to emerge.

FIG. 1—bottom block shows a high level diagram of the RFID reader connected to a secure authentication network.

FIG. 2—shows more detail on how this invention will be integrated into a payment terminal or payment kiosk.

FIG. 3—shows the devices integrated Security implementation.

FIG. 4—provides more details on this invention being integrated into a Cash Register, or Payment Terminal (payment kiosk or wireless payment system.

FIG. 5—shows the major elements of a Secure RFID authentication system using near field communications.

FIG. 6—shows communications messages associated with the major elements shown in FIG. 5.

FIG. 7—shows the Authentication Services, Authentication Challenges, and Private/Public Key Encryption Infrastructure.

FIG. 8—shows a cellular telephone authenticated within the authentication system.

FIG. 9—shows the network comprised of a product, an In Store Reader and Authenticator Services.

FIG. 10—shows the combination of a cellular phone with a plurality of NFC communications methods such as NFC for RFID communications, and NFC for wireless payment applications.

FIG. 11—shows the integration of an In Store Reader and/or Cash register.

FIG. 12—shows a Credit Card (or Debit Card) transaction being recorded on a cellular telephone.

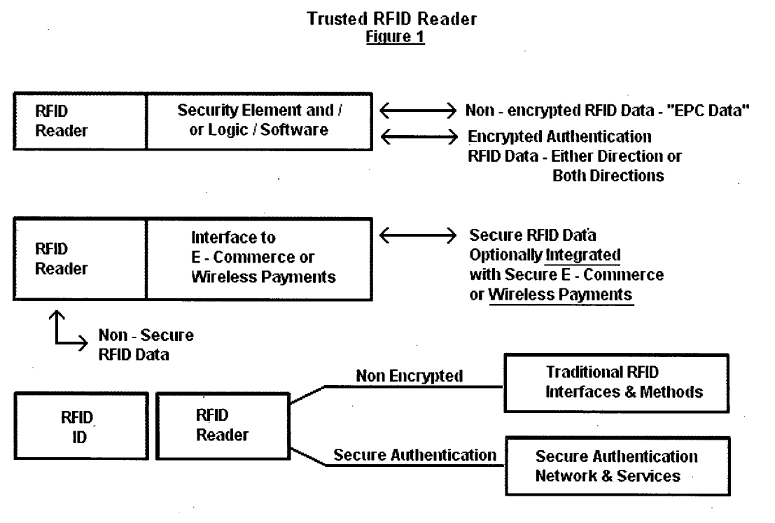

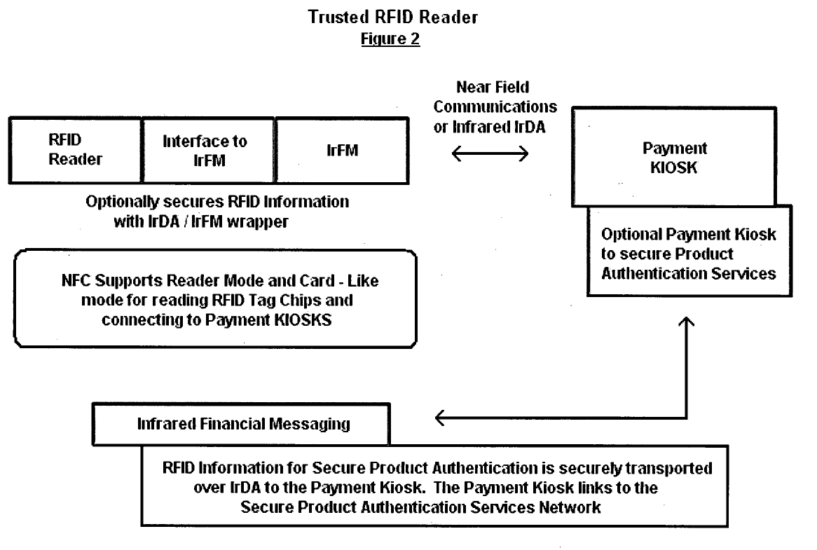

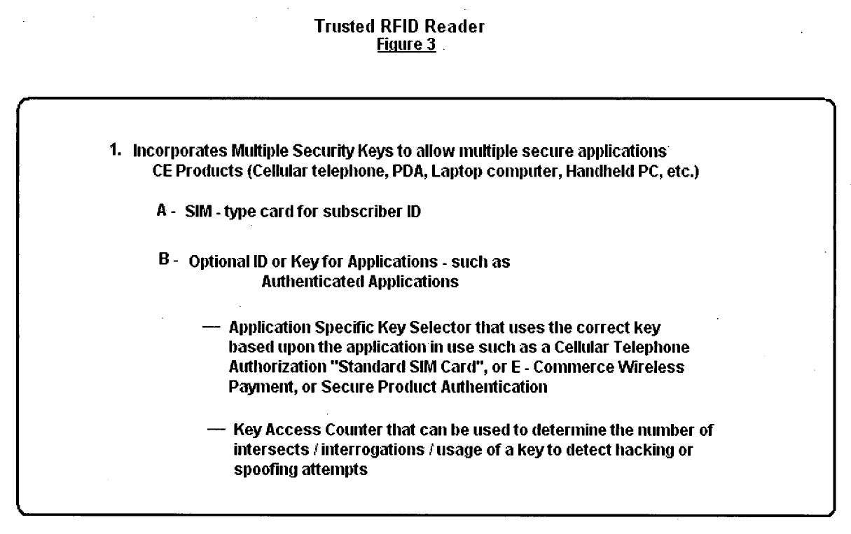

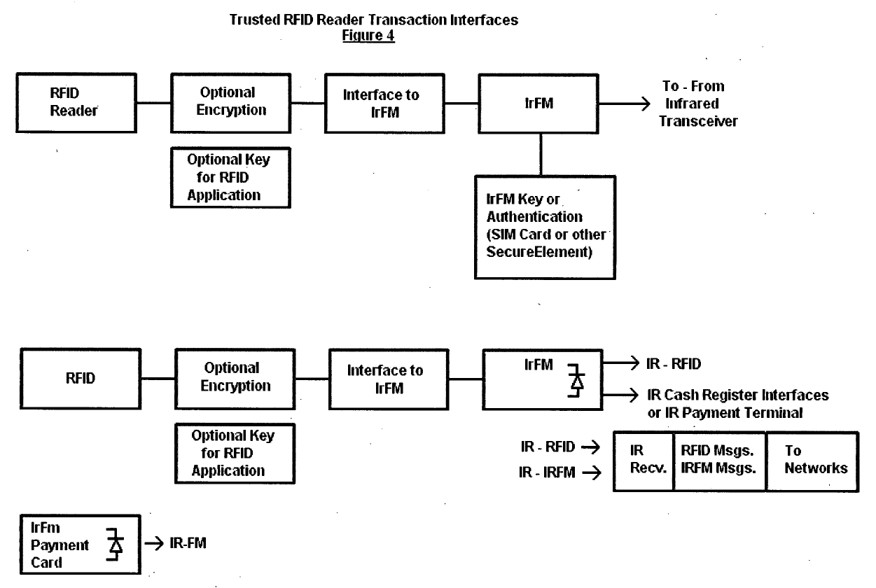

### DETAILED DESCRIPTION

(Note: Within this application, a reference to a cellular telephone may be denoted as either a cellular telephone, cell phone or phone.)

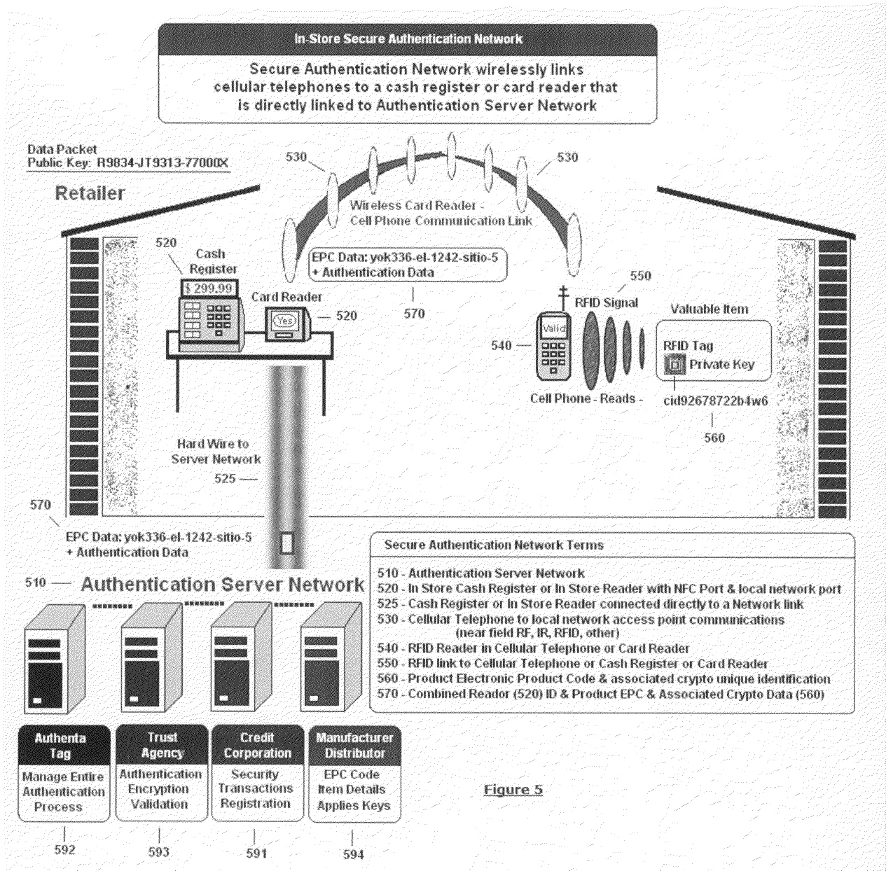

FIG. 5 shows the high level system components involved in the Purchase Authentication Network described herein.

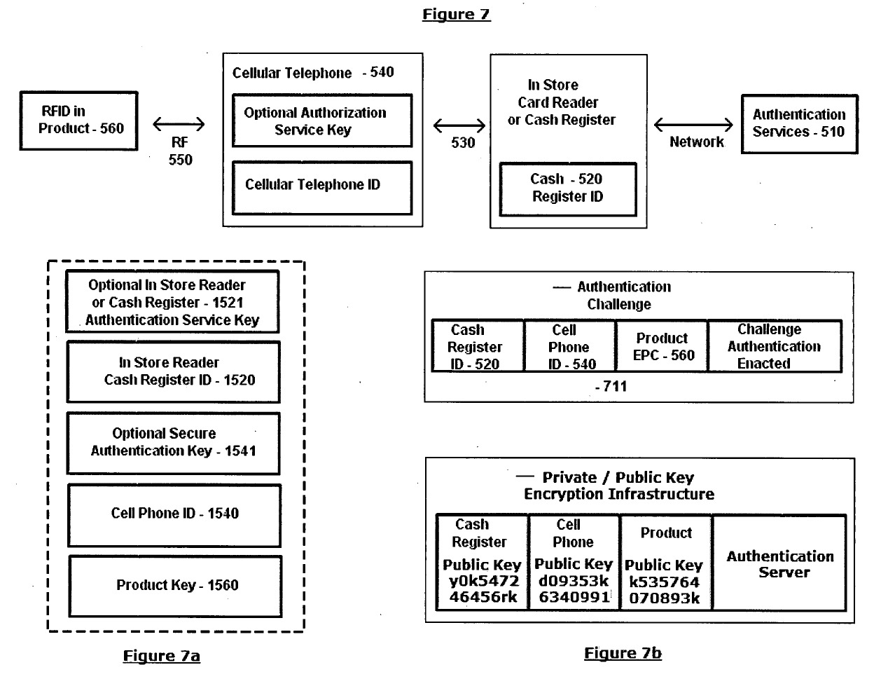

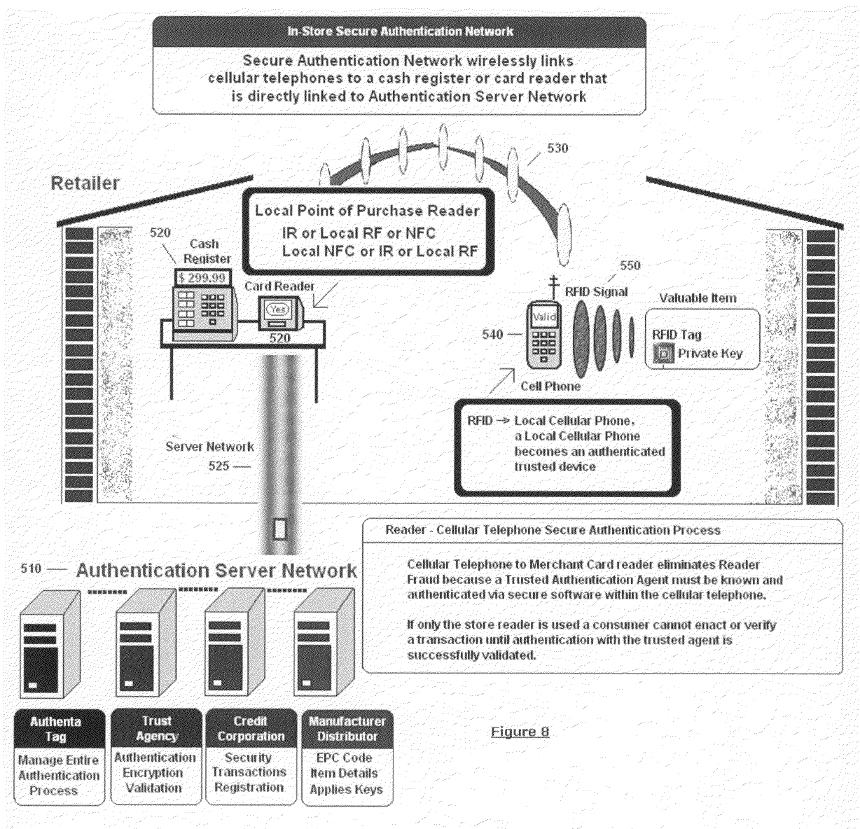

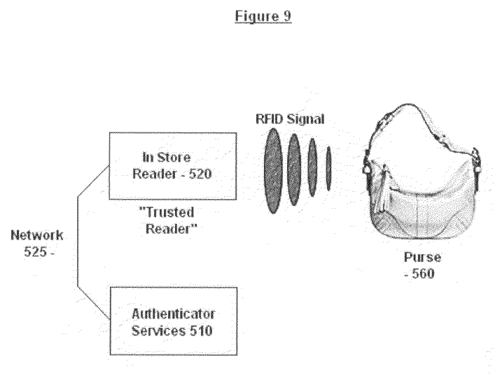

In FIG. 5 is a consumer product (valuable item 561) represented as a purse containing an RFID tag incorporating an Electronic Product Code (EPC) (560). EPC 560 optionally contains a cryptographically unique identifier (shown as key 1560 in FIG. 7A) for the product in addition to the normally unique, normally unencrypted EPC (id). The RFID tag may contain only the EPC, however a preferred embodiment of this invention incorporates a cryptographically unique identifier (Product—Cryptographic Unique ID (CUID) shown as key 1560 in FIG. 7A) in the product's RFID tag.

When only an EPC code is included in the RFID for a product and not a cryptographic unique ID such as a product key (1560 in FIG. 7A), authentication will not be as strong as when the RFID includes a CUID.

Item 540 is a consumer device incorporating an RFID reader and is represented as a cellular telephone. Item 540 can also be a PDA, Notebook, RFID reader, terminal, MP3 player, video ipod, standard ipod, etc. as described above).

Item 550 is a series of waves representing an infrared or RF wireless communications link between the product RFID tag 560 and a RFID reader (shown incorporated in the cellular telephone 540 but can also be a stand alone RFID reader as shown in element 520). In FIG. 5, a cellular telephone 540 includes an RFID reader to communicate with the product 560 RFID Tag and cellular telephone 540 also includes optional hardware/software elements to allow cellular telephone 540 to emulate an RFID (reader) to communicate with an in-store reader 520 via wireless communication path 530. Wireless communications path 530 and 550 can be a touch contact type communications link whereby phone 540 is connected by touching the phone 540 to a terminal (in this example reader 520), a wireless (infrared or Radio Frequency, or other), or a wired communications link. The important aspect of link 530 is that the phone 540 serves as the reader for the RFID tag during product 560 validation, and the link 530 serves as a local link from the phone 540 to a network connection via in-store hardware shown as a in-store credit card reader 520.

In store reader 520 (optionally consisting of an RFID Reader embedded or attached to a Credit Card Reader, and/or a separate RFID reader device) can also be contained within a cash register, a stand-alone terminal, or another network communication point (all not shown) to connect phone 540 to network 525, or to authenticate product EPC 560 when phone 540 is not used in the system.

In the preferred embodiment of this invention, in-store reader 520 does not need to be a ‘trusted reader’, rather the in-store reader can be a simple network access point (not trusted) access point for phone 540. When in-store reader is a simple network access point (not trusted) the phone 540 incorporates the security or encryption keys and authentication to allow Authentication Services 510 (also know as Trusted Authority) to establish secure, authenticated communications to phone 540 via public (unsecured) network 525 and local reader 520. When phone 540 incorporates encryption keys for authentication in-store reader 520 can be ‘trusted’ or secured as well, but it is not necessary to have card reader 520 to be trusted because the phone and authentication service 510 can establish a connection. Reader 520 can simply be a communications access point to allow phone 540 to network to Authentication Services 510.

Data 570 in FIG. 5 shows the EPC code or other ID information for the phone 540 including authentication data from phone. Authentication data can optionally include encapsulated product EPC 560 data as well as data to identify phone 540. Encapsulated product EPC 560 data is unique for the valuable item. Message data (example Data 570) can be optionally encrypted using the public key of the authentication server 510.

Reader 520 connects via network 525 to Authentication Services 510 (also know as Trusted Authority or Authentication Agent or Authentication Service from Prior Patent applications). Network 525 can be any form of local or wide-area network, the Internet, a wireless network, a VPN, or another type of network (secured or unsecured, or a combination of both) used to connect in-store reader 520 to Authentication Services 510. Network 525 can also include connection within a store to the stores in-store networking equipment (not shown) such as the network connections for local cash registers and credit card authorization equipment and will typically be behind a firewall. In fact, it is anticipated that in-store reader 520 can optionally be added to credit card authorization equipment that is used to read the magnetic strip contained on current credit cards or to cash register. In-store reader 520 can be added to smart card readers used for e-commerce applications or to cash registers. When added to current day credit card authorization equipment the in-store reader can share the communications path used when authorizing a credit card purchases with a credit card agency such as Visa or Master Card, or a separate communications path can be shared over a communications line (wired or wireless), or cash register connection or in-store computer network or other network that can be used to connect to Authentication Service 510.

Data element 570 in FIG. 5 shows information sent from the Phone 540 (or equivalent reader) to the Authenticator Services 510 and in 570 the EPC: includes phone identification information and routing information shown as yok336-5-149-el-sitio1024 plus authentication data (not detailed). The routing information can be used to identify the service subscriber (credit card holder for example, or subscriber to the Trusted Authentication Service) for automated product registration and is also used to establish or identify the keys necessary to perform secure trusted communications between Authentication Services 510 and Phone 540. Information can be encrypted and transmitted over a secure or unsecured communications network. Data element 570 can optionally be sent to Authentication Services 510 in encrypted format using a public key for Authentication Service 510 or other type of key such as a symmetrical key shared between Authentication Service 510 and phone 540. Data element 570 can also optionally be encrypted by in-store reader 520 in addition to encryption performed by phone 540 and Authentication Service will decrypt Data element 570 using decryption key necessary for encryption performed by in-store reader 520 and encryption performed by phone 540. Data element 570 represents only one message communicated between phone 540 and Authentication Service 510 and there are many other messages (example authentication results) that will be sent back and forth between phone 540, in-store reader 520, Authentication Services 510 and optionally product RFID 560.

It is anticipated by this invention that any data element shown in FIG. 5 representing the message flow between system elements (phone 540, in-store reader 520, network 525, trusted authority or other network elements) can be encrypted at each input/output point to the element with the system processing determining the appropriate encryption and decryption keys necessary.

For example, the table below shows the encryption and decryption applied when the phone 540 and in-store reader 520 and network access point from in-store reader (not shown but connects to network 525) encrypt/decrypt each input/output message.

| | Element | | | | |
|---|---|---|---|---|---|
| | from | | | | |
| Step | FIG. 5 | Input | Encryption and key | Output | Comments |
| 1 | Phone | Read of RFID | Encryption at this point | Encrypted RFID | Message header data |
| | 540 | 560 from item via | will use Unique key for | authentication | can optionally be |
| | | link 550. | Phone 540 registered with | message (or | encrypted. |
| | | RFID 560 read | Trusted Authority or | other message) | |
| | | from RFID chip | Service provider. | encrypted using | |
| | | can be unencrypted | Message encryption uses | a phone 540 | |
| | | or | the Unique key or ID for | unique key sent | |
| | | encrypted. | the Phone 540 | | |
| | | This step reads | | | |
| | | the products | | | |
| | | RFID. | | | |
| 2 | In-store | Receives output | Encryption (optionally | Message | In-store reader does |
| | Reader | message from | added at this point) will | containing | not need to add |
| | 520 | Step 1 | use a in-store reader | identifier of in- | additional |
| | | | unique key to encrypt the | store reader | encryption and can |
| | | | information received from | encapsulating | serve as an |
| | | | Step 1 above. | the message | encrypted or |
| | | | | received from | unencrypted |
| | | | | step 1 above. | gateway to allow |
| | | | | | phone 540 to |
| | | | | | communicate with |
| | | | | | Trusted Authority or |
| | | | | | Authentication |
| | | | | | Service |
| 3 | Network | Message output | Encryption (optionally | Message | Network access |
| | access | from Step 2 | added at this point) will | containing | point can optionally |
| | point | above. | use a network access | identifier of | encrypt messages at |
| | connecting | | point unique key to | Network Access | this point if part of |
| | in-store | | encrypt the information | Point | secure virtual |
| | reader | | received from Step 2 | encapsulating | network. |
| | 520 to | | above. | the message | |
| | network | | | received from | |
| | 525 | | | step 2 above. | |
| 4 | Authentication | Message output | Using the registered | Encrypted | This step can be |
| | Service | from Step 3 | decryption keys for any of | message from | combined with Step |
| | 510 | above | the encryption steps | step 1 above. | 5 below but has been |
| | connection | | added beyond step 1 | | separated into two |
| | to | | described above, remove | | steps to illustrate the |
| | network | | the network added | | removal of network |
| | 525 | | encryption from elements | | added encryption |
| | | | 520 and 525 (if any | | during the transport |
| | | | elements added | | of the message after |
| | | | encryption) | | Step 1. |
| 5 | Authentication | Encrypted | The service subscriber | Decrypted | |
| | Service | Message from | will be identified from the | messages, | |
| | internal | Step 1 above | received message and the | commands, and | |
| | processing | | subscriber key associated | data received | |
| | | | with phone 540 will be | from Phone | |
| | | | used to authenticate the | 540. | |
| | | | subscriber and decrypt | | |
| | | | messages, authentication | | |
| | | | requests, commands, and | | |
| | | | data from and to the | | |
| | | | phone 540 | | |
| 6 | Any of | Command, | Authentication Service | Encrypted | When used |
| | the | responses, and | will select appropriate | commands, | additional |
| | above | data destined | key(s) to encrypt | responses, and | encryption will be |
| | | for Phone 540 | commands, responses, | data messages | applied to message |
| | | or any network | and data messages | for Phone 540. | for decryption |
| | | element | destined for any of the | | along transit route |
| | | described above | network elements | | to Phone 540. |
| | | or a | shown in FIG. 5. At a | | Encryption can be |
| | | combination of | minimum the | | added for in-store |
| | | any network | appropriate key for | | reader 520 |
| | | element above | phone 540 will be used | | decryption, cash |
| | | and Phone 540 | to encrypt responses. | | register or store to |
| | | | Additional encryption | | network 525 |
| | | | can be added to Phone | | connection or |
| | | | 540 message and the | | other additional |
| | | | additional encryption | | network |
| | | | will be removed by | | communications |
| | | | appropriate network | | elements that may |
| | | | element. | | be in deployed |
| | | | | | network. |

Shown in the bottom of FIG. 5 are Authentication Services 510 related data bases and/or processing systems. The databases or processing systems are generic in nature and described as follows:

510—Authentication Server Network—Various device and Information Systems to facilitate the secure authenticated purchase of products using authenticated devices providing: a front end for the system communications with in-store readers, cellular network provided, cell phones, and other access devices such as stand alone readers, PDA, etc.

591—Security Transaction System—to register secure (credit card, debit cartd, etc.) transactions for product purchases conducted by authenticated devices.

592 Authenticator Management Systems—system to authenticate system users and system elements.

593 Trust Information Systems—database housing keys for system elements, system users, in-store readers, cash registers, and other network elements.

594 Manufacturer Information Systems—system to network with manufacturer databases to authenticate product EPC codes or product IDs.

For the above database elements it is envisioned by this patent application that there will be many way to implement the Authentication Server Network and the Trusted Authority processing and individual database elements shown can be added, remove or combined to implement the processing.

Collectively, these elements (591-594) will be called Back Office Processing and can be implemented in any fashion in a single or distributed manner. The processing has been described in the prior patent applications and would need to be enhanced to add the transport of data to and from the phone 540 and Authentication Services 510 via in-store reader 520 (or equivalent) and network 525. This enhancement can be in the form of additional routing information, network address information, optional encryption/decryption key registration (as appropriate and depending on encryption method) to have in-store reader 520 operate as a network communications access point for phone 540 to network 525. Routing information will be used to establish network connection from phone 540 to Authentication Service 510 or ultimate destination via phone 540 to in-store reader 520 protocol and in-store reader 520 to network thus establishing seamless, secure communications network between phone 540 and any other network elements. Appropriate encryption/decryption key hierarch compatible with above table showing message encryption/decryption is anticipated and required by this application. When a symmetrical key is used to encrypt or decrypt information at any stage in the above table, a key-pair associated with the element identified in the above table will be necessary. However, the preferred method of encryption/decryption is to use Public/private Key Infrastructure (PKI) encryption which would require the appropriate public/private keys (or X.509 digital certificates) to be stored in the elements to encrypt/decrypt messages using the appropriate public/private key. For examples, messages encrypted by the Trusted Authority 510 targeted for a particular in-store reader would encrypt the message traffic using the public key of in-store reader 520, then upon receiving the message in-store reader 520 would use its private key to decrypt the encrypted message and then forwarding the decrypted message by in-store reader 520 with message containing an encrypted message for the phone that can be decrypted by the phone.

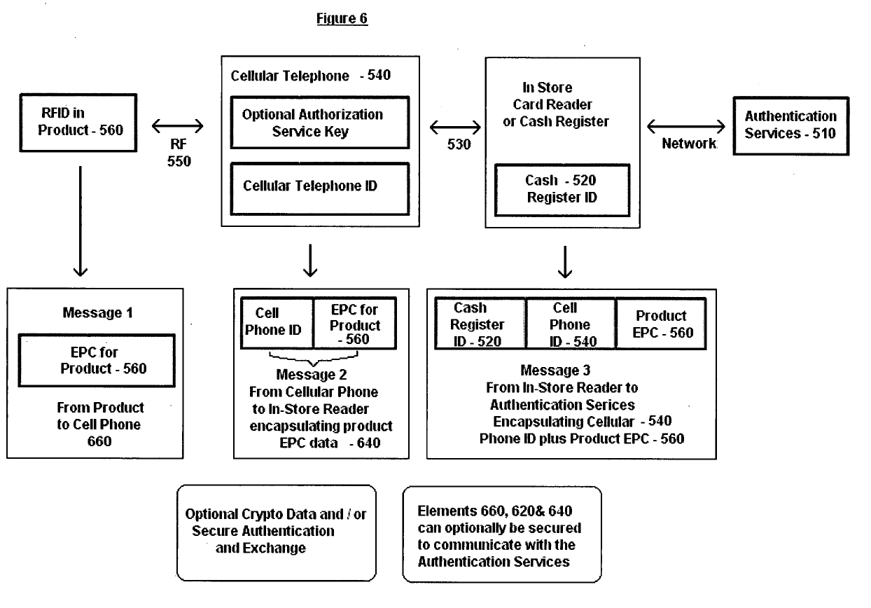

Referring now to FIG. 6, message encapsulation is shown for each of the elements at the top of FIG. 6 using element numbers corresponding to the major elements shown in FIG. 5. In FIG. 6 Message 1 (660) shows the EPC for Product 560 being sent from product to cell phone. Message 1 (660) can also go from product to in-store reader 520 when no cell phone is used during authentication. Message 1 (660) can be cryptographically secure and/or authenticated. Message 1 (660) is representative of one of many messages that will be sent and received by the RFID in product 560.

Using the techniques described in this patent the Secure RFID Authentication System is established using communications agents that can be trusted (encrypted in-store readers, Personal Computers, and/or store to network communications access points) or un-trusted using the same elements that are not authenticated.

The trusted element reference in this patent describes the element that contains cryptographic keys, a secure identifier, a smart card, encryption hardware with appropriate keys or other hardware or software that is used to encrypt and decrypt message traffic with other system elements.

FIG. 7A shows an example key hierarchy for the system. Product key 1560 is incorporated within the RFID in Product (560) and preferably consists of a public/private key for the RFID in addition to the normal Electronic Product Code EPC. Symmetrical key encryption can also be used but is less desirable. RFID 560 in product may not include a single or multiple set of keys for low monetary value items.

Cell phone ID 1540 can be as little as the SIM card ID and keys for the cellular phone 540, but preferably includes an additional key to allow the Authentication Service 510 to authenticate the phone 540 using a key or identifier different than the one used by the wireless cell phone provider to identifier the subscriber (typically called a SIM card, SIM, BAM, or cellular phone Subscriber ID).

FIG. 7A also shows an optional security key (1541) added within phone that is an additional key or cryptographically unique ID to the SIM cards ID and/or keys. Optional security key 1541 can be a private key pair shared only with the Authentication Service 510 or a public/private key pair or other keys used to authenticate the RFID as described in the prior patents.

FIG. 7A shows an ID (1520) for the in-store reader or cash register that is used by the phone 540 to communicate with Authentication Service 510 via network 525. In-store reader preferably contains an optional authentication key 1521 to allow the Authentication Service 510 to authenticate the in-store reader 520, and/or perform encrypted communications between in-store reader 520 and Authentication Service 510.

The in-store reader can include a separate key pair that is used to authentic the in-store reader by the stores internal network processing thus establishing a secure in-store private network in addition to the secure end-to-end network described above.

FIG. 7B shows the public keys 1,2, and 3 that can optionally be added to allow the product RFID 560, phone 540, and in-store reader 520 to use PKI (private/public key encryption infrastructure) to communicate with the Authentication Service 510. Note that none, or any one, two, or all three of the keys shown in FIG. 7B can be used to encrypt communications with the Authentication Service 510.

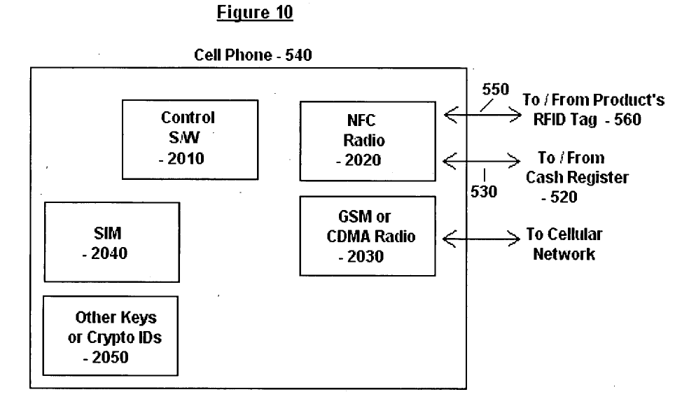

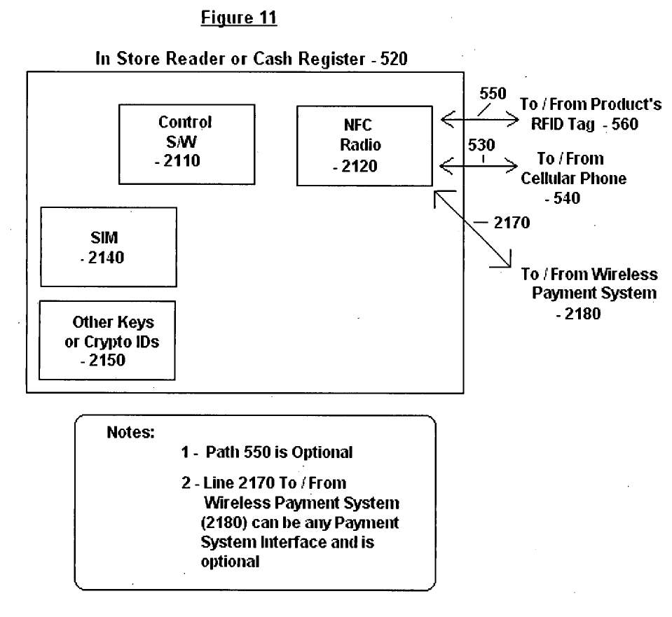

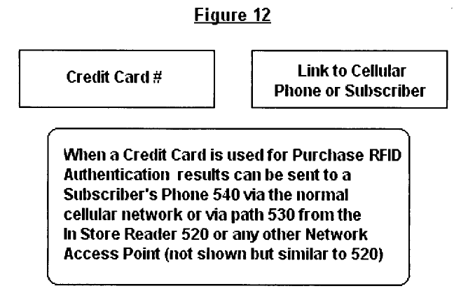

FIG. 10 shows a plurality of NFC communications options incorporated into a single cell phone 540. Shown in FIG. 10 is the NFC radio 2020 that may include RF, infrared, or other wireless communications capability. NFC Radio 2020 will contain the baseband processing and protocol layer processing necessary to interface to a single or plurality of systems such as IRDA for infrared payment or infrared communications, RFID reader, and other NFC capabilities such as Zig-Bee, Bluetooth, 802.11xx, or others. At a minimum NFC Radio 2020 will communicate using one radio standard and will support radio paths 550 and 530 shown in FIG. 10. The Radio 2020 (or similar access point or communications link) will be based on functionality as follows:
1. Phone 540 will read product RFID 560 using NFC Radio 2020—NFC Radio 2020 will perform the steps necessary to read the RFID information from within products RFID 560.
2. After reading products RFID 560 Cell Phone 540 will communicate with in-store reader or cash register 520 (or other network access point) via path 530. (Note that paths 550 and 530 are shown as two distinctive paths but in actual implementation may be one path with different messages, or messages IDs, or addressing for the different message paths.
3. Phone 540 will listen for response from in-store reader or cash register 520 (or other network access point) via path 530.

The above steps are for illustrative purposes and someone skilled in the art can substitute other steps and paths without loosing the essence of this invention.

An alternative method will have circuitry in NFC Radio 2020 to simultaneously communicate via paths 550 and 530 to two different remote units, one being the RFID 560 in a product and the second being a cash register or in-store reader 520 or other network access point.

Cell phone 540 will have activation methods (preferably via automatic control) to enable one or multiple NFC communication options and such activation will typically be selected by the cell phone application being used by the cell phone user. For example, if the cell phone user desires to perform product authentication of an RFID tag using the “authenticate” feature of the cell phone's graphical user interface consisting either of a virtual display button ‘-A-, or -Auth-, or Auth-Purchase, or Authenticate or Authenticate- Purchase’ or a physical ‘-A-, or -Auth-, or Auth-Purchase, or Authenticate or Authenticate- Purchase’ button residing on the phone, then the cell phone will activate the RFID reader portions of the NFC radio or touching the product containing the RFID. It is envisioned by this application that multiple simultaneously operating NFC radios or physical RF interfaces can be operating concurrently but this is not necessary whereby the NFC radio is time shared between applications to conserve phone battery power.

Also shown in FIG. 10 are Other Keys or Crypto IDs 2050. These keys can be cryptographically unique keys or identifiers associated with different service levels or authentications such as Phone 540 to Authentication Service authentication, Phone 540 to in-store network services and encryption, Phone 540 to RFID 560 services and encryption, etc.

Software control 2010 in FIG. 10 is used to coordinate the operation of the NFC Radio 2020 and associated radio paths, Cellular/GSM/CDMA/wireless radio 2030, SIM card control 2040, Other Keys/Crypto IDs 2050. Software control 2010 also performs necessary processing to authenticate Cell Phone 540 with Authentication Service provider.

We claim:

1. A cellular phone wherein said cellular phone includes a RFID tag reader and application software to communicate via a second radio link in said telephone to a local access point wherein said local access point is used to provided access to an authorization service wherein the said authorization service authenticate said RFID tag.
